(19) United States
(12) Patent Application Publication
(10) Pub. No.: US 2009/0096579 A1
(43) Pub. Date: Apr. 16, 2009

(54) Drivers' License Verification Program

(76) Inventor: Will Arcas, Miami, FL (US)

Correspondence Address: CHRISTOPHER J. VANDAM, P.A., 19600 NE 21 Ct., MIAMI, FL, 33179, US

(21) Appl. No.: 11/872,599

(22) Filed: Oct. 15, 2007

(51) Int. Cl. G05B 19/00

(52) U.S. Cl. 340/5.86

(57) ABSTRACT

The present invention is a computer based process and method that in the preferred embodiment uses stored information about a driver including, inter alia, the driver's name, driver's license number and contact information. The driver's license number is queried against a licensing authority's database returning results including, inter alia, whether a specific driver's license is valid, pending suspension or suspended and the reason for the status which may include, for example, a pending violation, court ordered revocation or suspension, no proof of insurance recorded, non-renewal or other causes.

### BACKGROUND OF THE INVENTION

1. Field of the Invention

The present invention relates to a program to verify drivers' licenses, and more particularly, to a program that verifies the status of drivers' licenses.

2. Description of the Related Art

Several designs for drivers' license verification programs have been designed in the past. None of them, however, includes a program that verifies the status of a drivers' license with a licensing authority either by downloading data from the licensing authority or uploading the licensee information to compare and confirm with the licensing authority the status of drivers' licenses.

Applicant believes that the closest reference corresponds to U.S. patent application publication No. 2006/0095304 filed by Bill Madison et al. However, it differs from the present invention because, inter alia, the present invention does not review an individual's motor vehicle record for incidents or different classes of data but instead checks for the status of that individual's driver's license.

Other patents describing the closest subject matter provide for a number of more or less complicated features that fail to solve the problem in an efficient and economical way. None of these patents suggest the novel features of the present invention.

### SUMMARY OF THE INVENTION

A drivers' license verification computer program comprised of a Requester's database with information about multiple drivers comprising the name of the driver, contact information for the driver and driver's license number for each driver; said drivers' license numbers are sent over the internet to a licensing authority and queried against the licensing authority's database of drivers for the status of each driver's license; results comprised of each license number paired with the status of the license for each license are received by the Requester; each license number received with a status other than “valid” is presented in a report with other information about the driver contained in the Requester's database.

The driver's license verification computer program may be further characterized in that said status of the driver's license is comprised of valid, pending suspension, suspended or revoked.

The driver's license verification computer program may be further characterized in that said status of the driver's license is comprised of valid, pending suspension, suspended or revoked and the reason for said status of the driver's license.

The driver's license verification computer program may be further characterized in that said report is generated and comprises said driver's name, driver's contact information, driver's license number and reason for said status.

The driver's license verification computer program may be further characterized in that said report is delivered to a group comprised of any of said driver, driver's employer, driver's insurance carrier, driver's insurance agent or driver's guardian.

The driver's license verification computer program may be further characterized in that if said status of the driver's license is anything but “valid” because the licensing authority does not report having proof of insurance in file and the driver has a valid insurance policy in effect then the Requester generates a report and sends the report to the licensing authority thereby updating the licensing authority's records.

It is one of the main objects of the present invention to provide a program to check the status of a person's driver's license.

It is another object of this invention to provide a means for an insurer, insurance agent or employer to verify the status of a person's driver's license.

It is still another object of the present invention to provide an automobile insurance agent a means to monitor the status of customers' driver's licenses to aid in the process of ensuring that the licensing authority has up-to-date proof that a driver is insured.

It is yet another object of this invention to provide such a program that is easy to use and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a flow chart of the processes of the preferred embodiment.

FIG. 2 represents a sample driver database.

FIG. 3 is a sample user interface screen.

FIG. 4 is a sample report.

FIG. 5 is a sample report.

### DETAILED DESCRIPTION OF THE PREFERRED EMBODIMENT

As is well known, drivers of vehicles are required to be licensed to operate a particular class or type of vehicle. A common non-commercial driver's license often requires passing a written or oral exam, a road test, proof of insurance of the driver's vehicle or other requirements. Additional requirements are made of drivers of commercial vehicles, motorcycles, boats, aircraft, taxi cabs, limousines, vehicles for hire and heavy trucks. Drivers' licenses often must be renewed or have other periodic requirements to obtain and maintain the validity of the driver's license.

Licenses may become invalid for a number of reasons. For example the licensee fails to renew the license, driving infractions, court orders, failing to meet currency of endorsements, failing to provide proof that the driver's vehicle is insured and the like.

An unfulfilled need has been observed to provide a process and method for interested persons to periodically ensure that a license is valid. For example the operator of a fleet of taxi cabs, limousines, commercial vehicles and heavy trucks may have the desire or duty to ensure that the drivers operating the vehicles are duly licensed. Similarly a parent may desire to monitor a dependent's license to help ensure that the driver appropriately licensed, free of driving infractions and properly insured.

Yet another practical application of the present technology is for an insurance underwriter or agent to ensure that their customers are legally operating their vehicles. The status of a driver's license may be a factor in the underwriting process or may be used to serve as an aid to drivers who have mistakenly allowed their license to become invalid.

One preferred use of the present technology is to aid a vehicle insurance agent or company by ensuring that its customers maintain a valid license and to check for errors in a licensing authority's records. For example, many states require that proof that a driver's vehicle is insured as a requirement to maintain a driver's license. Commonly a licensing authority, such as state's department of motor vehicles, requires a showing of proof of insurance to renew a license. A vehicle insurance agent may be able to provide a valuable service to a customer by ensuring that the driver's record with the licensing authority is up to date and accurate. It can be embarrassing and problematic for a driver whose records with the licensing authority are inaccurate. Conversely, the present invention may be able to help a driver by notifying their vehicle insurance agent that the insurance records should be updated or a current policy purchased from the agent.

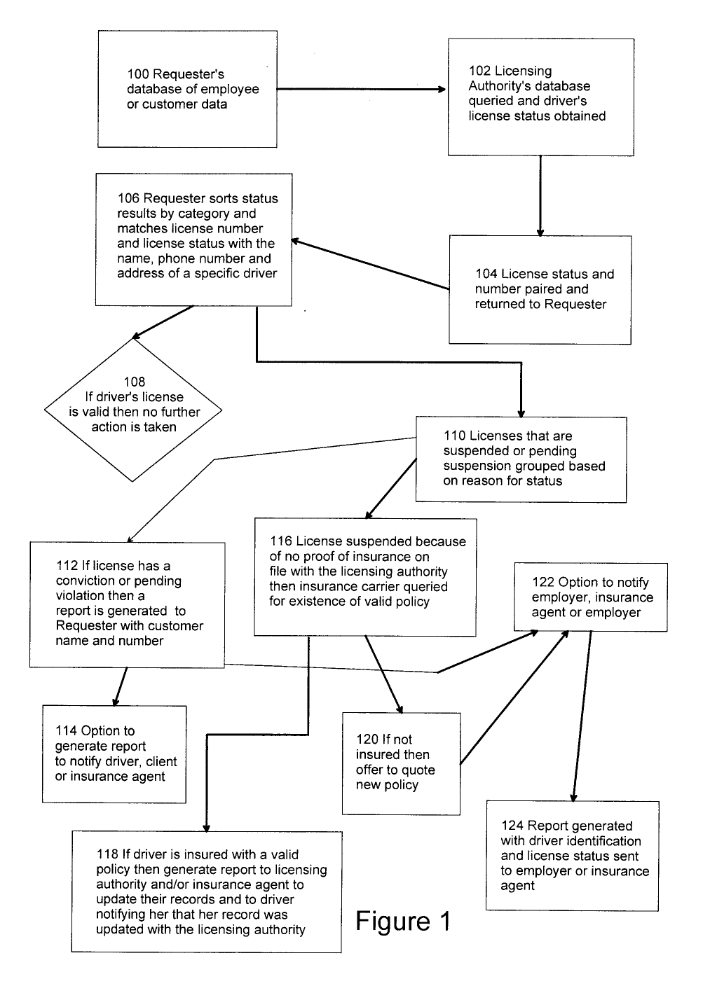

Referring now to the drawings, where the present invention is generally described in FIG. 1, it can be observed that it basically includes a process and method for drivers' licenses to be verified against a licensing authority's database accessible through the internet. The status of a license is then returned to the requester, the requester's computer then may take any of several actions based on the results returned. For example, if the license is shown to be valid then no action need be taken. Optionally, a report may be generated to confirm that the verification occurred and create a printed or digital report of the results. If, for example, the license is suspended, pending suspension or revoked a report can be generated to notify a relevant person to take actions to remedy the situation. A relevant person may be, for example, a parent, manager of drivers, insurance agent or other person who may desire to know the status of a driver's license.

In the preferred embodiment the process begins at step 100 where the requester has a computer database of driver information. Typically driver information would be comprised of, inter alia, the driver's name, license number, address, contact information, license issuing authority identifier (often a state department of motor vehicles), and insurance policy information, typically from an insurance agency. A requester could typically be a fleet manager, parent of children that drive, insurance agent, insurance underwriter or anyone who may have an interest in the validity of someone's driver's license.

The requester's computer at step 100 then compiles a set of information necessary for the licensing authority to identify the licensee. Typically this could be as basic as a compilation of drivers' license numbers but also may include such information as the drivers' names, addresses or other information that the licensing authority may require to identify a driver.

The requester's computer is then instructed at step 102 to query the licensing authority's database over the internet with the licensees' identifying information and returning results to the requester in step 104 including, inter alia, the status of each license paired with an identification of the licensee. Other data returned from the query could optionally include whether the insurance information is current and the reason for invalidity if a license is not current or valid.

Once the status and driver identification information is returned to the requester that information is reunited in the requester's computer in step 106 with contact information of the licensee including, inter alia, the driver's name, address and phone number. As shown in step 108, if a driver's license is valid then no additional action need be taken in regard to that driver. Optionally, step 108 could include generating a report identifying the driver or list of drivers searched with an indication that a search was conducted and the result was a valid driver's license. Optimally, this report would include the status of each license, enough information to positively identify the driver or drivers, indicate which licensing authority's databases were searched and the time of the search.

As shown instep 110, any license status that is anything other than valid is further sorted into categories based on the status and the reason for that status. If the license is not valid due to a conviction or pending violation then a report is generated and sent to the requester in step 112, inter alia, identifying the driver, the driver's contact information and reason that the license is not valid. The requester can then optionally contact the driver to notify the driver of the license status or investigate the circumstances further. Step 112 gives the requester the additional option to generate a report as the situation requires. For example, in step 122 an option is presented to the requester to notify the driver's employer or fleet manager and if the user opts to do so a report is then generated in step 124 and a report is sent. Also optionally a report can be generated and sent to the driver as shown in step 114.

If in step 110 it is determined that one or more drivers do not have a valid driver's license due to the licensing authority not reporting that a driver does not have proof of insurance recorded that group of drivers proceeds to step 116 where the requester's computer queries the insurance carrier associated with the driver if noted in the requester's database of employee or customer information. If there is no insurance carrier noted multiple insurance carriers may be queried with the employee or customer data to determine is a valid vehicle insurance policy is in effect for a particular driver.

If upon conducting the query in step 116 to determine if there is a valid policy in effect for a particular driver no valid policy can be identified a report is generated to the requester in step 120 to offer the driver a new policy. Step 120 is an appropriate step if the requester is qualified to sell the driver an insurance policy. Step 122 also provides an option to notify the driver's employer or fleet manager and if selected a report can be generated in step 124.

For some drivers it may be the case that at step 116 a valid vehicle insurance policy is found to be in effect. This may be due to a number of reasons, including for example, the licensing authority may not have properly updated their records or the driver failed to provide proof of insurance when renewing their license. If the license status of any driver can be made valid by providing the licensing authority with the appropriate proof of insurance a report may be generated in step 118 to correct the driver's record with the licensing authority and thereby make the license valid. This can be of particular benefit of an insurance agent who can now provide an added benefit to her customer by notifying the customer and make the necessary showing to licensing authority to avoid an embarrassing situation if the driver is questioned by a law enforcement officer and get a citation for failure to demonstrate proof of insurance.

It should be noted that any of the generated reports described above may be a printed paper hardcopy and mailed or otherwise delivered to the appropriate person and/or an email, text message, audio message or any other convenient and available means to deliver information to the intended recipient.

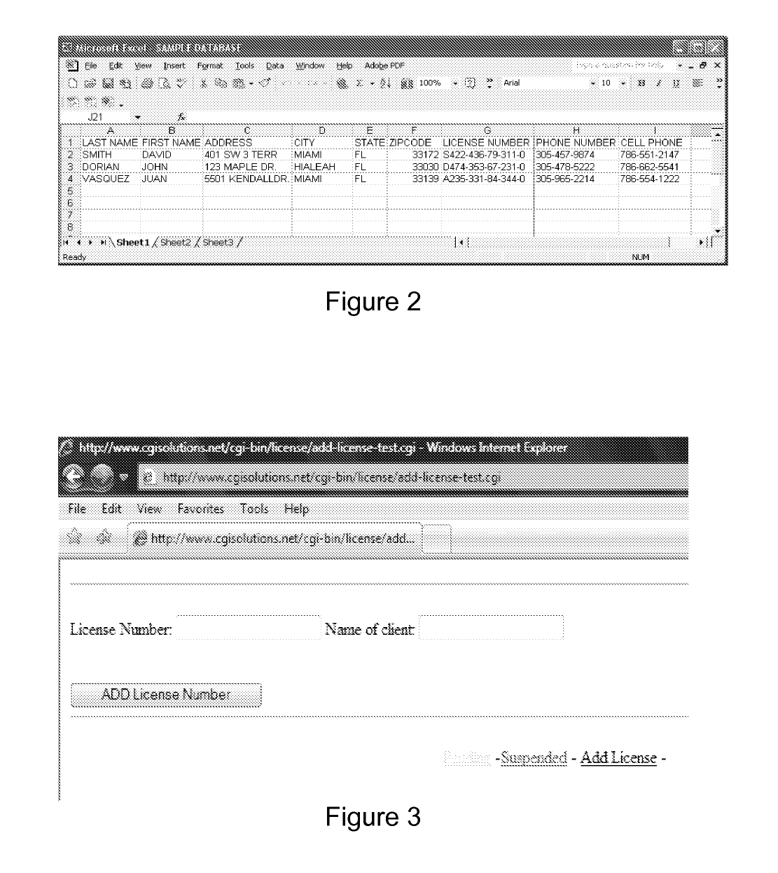

Referring now to FIG. 2 where a sample database is shown. The sample database may contain, inter alia, a driver's last name, a driver's first name, a driver's address, city state and zip code, a driver's license number and phone numbers. Typically an entry would be made for each driver whose license is monitored. Generally, this database is maintained by the Requester on their computer. Each individual entry may be, for example, customers, clients, employees or dependents. The database should contain enough information about a driver to identify them by name and driver's license number and contact information sufficient to contact them.

FIG. 3 is an example of a user interface form where a user of the program may add a driver to a database of drivers. Once a driver's information is entered into the appropriate places on the form it is sent to and integrated with the database of drivers. Optionally, the system will check to avoid duplicate entries of the same driver.

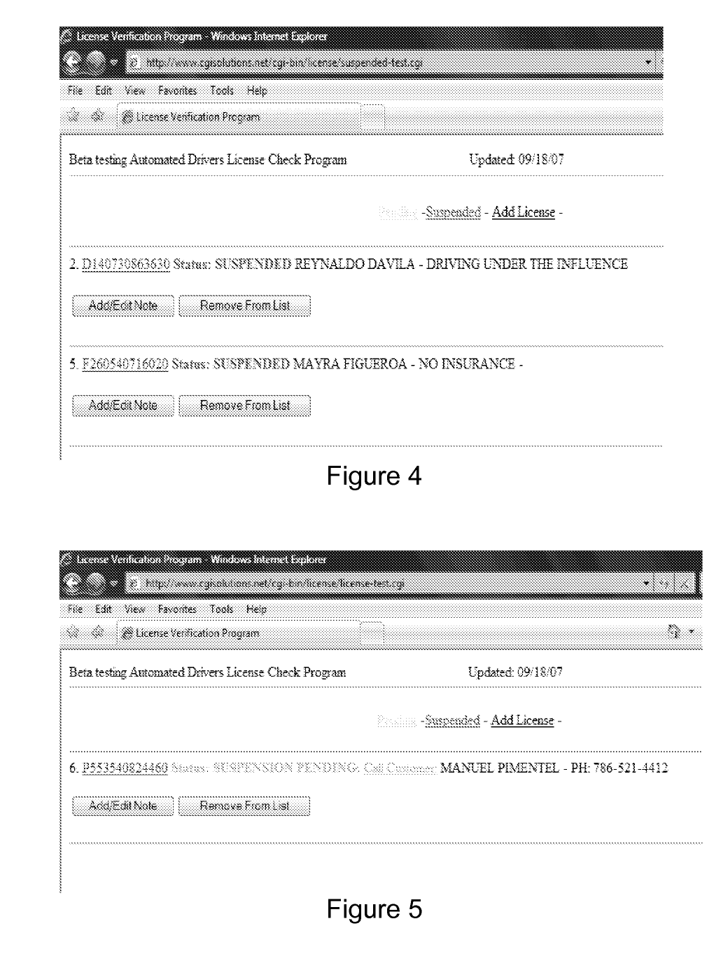

FIGS. 4 and 5 are examples of reports that may be generated after the program has queried a licensing authority's database. In these examples it can be seen that relevant information is presented to the Requester in a report with appropriate information such as the driver's license number, status and name. Additional information may also be presented in the report if relevant and may include a reminder to call a driver, phone number and reason for the status of a license. Generally, if a license number is checked against the licensing authority's database and the license is reported as valid it is not displayed. The Requester can select to add or edit a note associated with the driver or remove the driver from the database of drivers from the report.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A drivers' license verification computer program comprised of A Requester's database with information about multiple drivers comprising the name of the driver, contact information for the driver and driver's license number for each driver; said drivers' license numbers are sent over the internet to a licensing authority and queried against the licensing authority's database of drivers for the status of each driver's license; results comprised of each license number paired with the status of the license for each license are received by the Requester; each license number received with a status other than “valid” is presented in a report with other information about the driver contained in the Requester's database.

2. A driver's license verification computer program as in claim 1 further characterized in that said status of the driver's license is comprised of valid, pending suspension, suspended or revoked.

3. A driver's license verification computer program as in claim 1 further characterized in that said status of the driver's license is comprised of valid, pending suspension, suspended or revoked and the reason for said status of the driver's license.

4. A driver's license verification computer program as in claim 1 further characterized in that said report is generated and comprises said driver's name, driver's contact information, driver's license number and reason for said status.

5. A driver's license verification computer program as in claim 1 further characterized in that said report is delivered to a group comprised of any of said driver, driver's employer, driver's insurance carrier, driver's insurance agent or driver's guardian.

6. A driver's license verification computer program as in claim 1 further characterized in that if said status of the driver's license is anything but “valid” because the licensing authority does not report having proof of insurance in file and the driver has a valid insurance policy in effect then the Requester generates a report and sends the report to the licensing authority thereby updating the licensing authority's records.
